(19) United States
(12) Patent Application Publication
(10) Pub. No.: US 2024/0289793 A1
(43) Pub. Date: Aug. 29, 2024

(54) SYSTEMS AND METHODS FOR TRANSACTION VALIDATION IN LAYER 2

(71) Applicant: BLOCKCHAINS, INC., Sparks, NV (US)

(72) Inventors: Simon Jentzsch, Sparks, NV (US); Christoph Jentzsch, Sparks, NV (US); Steffen Kux, Sparks, NV (US)

(73) Assignee: BLOCKCHAINS, INC., Sparks, NV (US)

(21) Appl. No.: 18/573,212

(22) PCT Filed: Jun. 21, 2022
(86) PCT No.: PCT/US2022/034300

§ 371 Date: Dec. 21, 2023

Related U.S. Application Data
(60) Provisional application No. 63/213,461, filed on Jun. 22, 2021.
(60) Provisional application No. 63/327,899, filed on Apr. 6, 2022.

(51) Int. Cl. G06Q 20/40; G06Q 20/38

(52) U.S. Cl. CPC G06Q 20/401; G06Q 20/3825

(57) ABSTRACT

Systems and methods for validating transactions distributed ledger transactions. In some embodiments, a request may be received to validate a proposed transaction for layer 2 processing for a distributed ledger. In response, a cryptographic configuration involved in the proposed transaction may be identified, and the proposed transaction may be checked against one or more transaction rules of the cryptographic configuration. In response to successfully checking the proposed transaction against the one or more transaction rules of the cryptographic configuration, the proposed transaction may be signed as part of a joint signature process with a validation key associated with the cryptographic configuration.

### RELATED APPLICATIONS

This application claims priority benefit under 35 U.S.C. § 119(e) to U.S. Provisional Application No. 63/213,461, filed Jun. 22, 2021, entitled “SYSTEMS AND METHODS FOR TRANSACTION VALIDATION IN LAYER 2,” bearing Attorney Docket No. C1494.70006US00, and U.S. Provisional Application No. 63/327,899, filed Apr. 6, 2022, entitled “SYSTEMS AND METHODS FOR TRANSACTION VALIDATION IN LAYER 2,” bearing Attorney Docket No. BLK-006US02, each of which is incorporated by reference herein in its entirety.

### BACKGROUND

Distributed ledger technologies have been adopted for numerous applications, such as cryptocurrency, supply chain data management, healthcare data management, etc. However, many distributed ledger implementations have scalability challenges. For instance, to provide a high level of security and/or decentralization, one or more measures of computational complexity (e.g., message, time, and/or space) may be increased. Such challenges have prompted development of layer 2 technologies, which provide improved scalability over underlying distributed ledger technologies.

### SUMMARY

In accordance with some embodiments, a computer-implemented method is provided for # validating distributed ledger transactions, the method comprising acts of receiving a request to validate a proposed transaction for layer 2 processing for a distributed ledger, identifying a cryptographic configuration involved in the proposed transaction, checking the proposed transaction against one or more transaction rules of the cryptographic configuration, and in response to successfully checking the proposed transaction against the one or more transaction rules of the cryptographic configuration, participating in jointly signing the proposed transaction with a validation key associated with the cryptographic configuration.

In accordance with some embodiments, a system is provided, comprising at least one processor and at least one computer-readable storage medium having stored thereon instructions which, when executed, program the at least one processor to perform any of the methods described herein.

In accordance with some embodiments, at least one computer-readable storage medium is provided, having stored thereon instructions which, when executed, program at least one processor to perform any of the methods described herein.

### BRIEF DESCRIPTION OF DRAWINGS

FIG. 1 shows an illustrative distributed ledger 100, in accordance with some embodiments.

FIG. 2 shows an illustrative layer 2 service 200, in accordance with some embodiments.

FIG. 3 shows an illustrative transaction validation service 300, in accordance with some embodiments.

FIG. 4 shows an illustrative process 400 for validating a transaction, in accordance with some embodiments.

FIG. 5 shows an illustrative process 500 for maintaining a cryptographic configuration, in accordance with some embodiments.

FIG. 6 shows an illustrative process 600 for deploying a cryptographic configuration, in accordance with some embodiments.

FIGS. 7A-C show, respectively, illustrative user devices 700A-C, in accordance with some embodiments.

FIG. 8A shows an illustrative proxy contract copy 800A and an illustrative privacy service 805, in accordance with some embodiments.

FIG. 8B shows the illustrative wallet application 120 sending a transaction directly to a main contract copy 810A in the example of FIG. 8A, in accordance with some embodiments.

FIG. 9 shows, schematically, an illustrative computer 1000 on which any aspect of the present disclosure may be implemented.

### DETAILED DESCRIPTION

Aspects of the present disclosure relate to systems and methods for validating transactions in connection with layer 2 technologies.

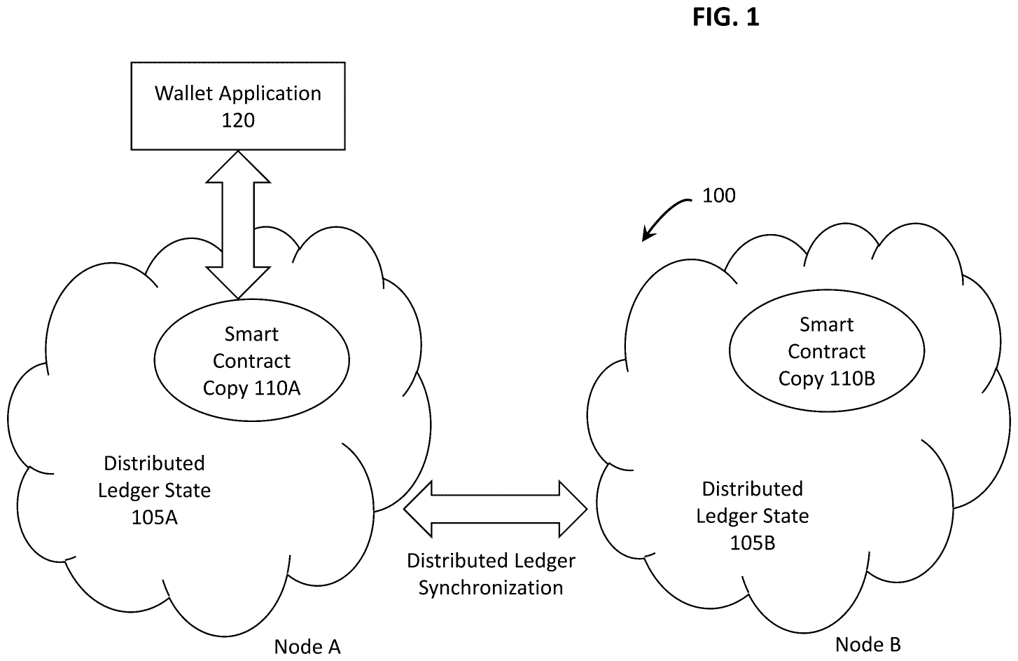

FIG. 1 shows an illustrative distributed ledger 100, in accordance with some embodiments. The distributed ledger 100 may be maintained collectively by a network of nodes, such as node A and node B. The nodes in the network may be operated by the same entity or different entities. An entity of any suitable type may operate a node, such as an individual user, a private organization, a government agency, etc.

In some embodiments, the distributed ledger 100 may include digital records replicated among one or more nodes in the network. For instance, the nodes A and B may manage distributed ledger states 100A and 100B, respectively. The nodes in the network may carry out a synchronization protocol, whereby a transaction that changes a digital record may be propagated through the network, and all nodes may update their respective copies of that digital record accordingly.

In some embodiments, the distributed ledger 100 may be implemented using a blockchain. The blockchain may include a plurality of blocks, where each block may include a plurality of transactions that are ordered chronologically, or in some other suitable manner. Additionally, or alternatively, each newly added block may be linked to a latest previous block. For instance, the new block may include a cryptographic hash of the previous block. Such a structure may provide tamper resistance, and may therefore be used to confirm whether a given transaction did take place, and/or when that transaction took place relative to one or more other transactions.

In some embodiments, a new block may be added to the blockchain only if all nodes in the network, or a subset of nodes with sufficient computation power, agree on the block. Any suitable distributed consensus technique may be used to reach an agreement. For instance, the fastest node to solve a computationally intensive mathematical puzzle (e.g., identifying a preimage of a hash with a certain number of leading zeros) may be selected to add the next block. Depending on how much computation power is available in the network at a given point in time, a more or less complex mathematical puzzle may be used, so that each new block may be added within a selected window of time.

In this manner, a malicious entity may have to control a large portion (e.g., more than 50%) of the network's computation power to mount a successful attack. To incentivize participation of honest entities, a node may be rewarded with an internal digital asset (e.g., a bitcoin) each time that node is selected to add the next block.

It should be appreciated that aspects of the present disclosure are not limited to using a proof-of-work approach to achieve distributed consensus. Additionally, or alternatively, a proof-of-stake approach may be used, where nodes are selected according to their respective stakes in a cryptocurrency. It should also be appreciated that any suitable blockchain implementation may be used, such as Ethereum, Hyperledger Fabric, etc.

Furthermore, aspects of the present disclosure are not limited to using a blockchain to implement a distributed ledger. In some embodiments, one or more directed acyclic graphs (e.g., IOTA Tangle), hashgraphs (e.g., Swirlds), hash trees (e.g., Guardtime keyless signatures infrastructure), and/or distributed ledgers with no globally-shared chain (e.g., R3 Corda), may be used in addition to, or instead of, one or more blockchains.

In some embodiments, one or more smart contracts may be deployed on the distributed ledger 100 in the example of FIG. 1. A smart contract may include any suitable program logic, such as program logic that indicates one or more events and/or one or more actions to be performed in response to the one or more events. For instance, an event may include a transaction involving the smart contract, and a corresponding action may include an update to a state of the smart contract as a result of the transaction. Such a smart contract may be deployed via a transaction, whereby program logic of the smart contract may be recorded on the distributed ledger 100.

In some embodiments, a smart contract deployed on the distributed ledger 100 may be enforced collectively by the network of nodes maintaining the distributed ledger 100. For instance, the nodes A and B may maintain, respectively, copies 110A and 110B of a smart contact. Each copy of the smart contract may include program logic and/or a state of the smart contract. When a transaction involving the smart contract is propagated through the network of nodes, each node may independently execute the program logic of the smart contract to determine how to update the state of the smart contract.

If the smart contract copies 110A and 110B are identical prior to the transaction, the nodes A and B may execute the same program logic from the same beginning state in response to the same transaction, and therefore may arrive at the same end state. Additionally, or alternatively, a suitable distributed consensus technique (e., proof-of-work or proof-of-stake) may be used, so that the nodes A and B execute the same set of transactions in the same order. Thus, the smart contract copies 110A and 110B may remain consistent despite independent executions by the nodes A and B.

It should be appreciated that aspects of the present disclosure are not limited to storing program logic or a state of a smart contract on the distributed ledger 100. In some embodiments, a proof (e.g., a cryptographic hash or a non-interactive zero-knowledge proof) may be generated from program logic and/or a state of a smart contract. Such a proof may be stored on the distributed ledger 100, in addition to, or instead of, the program logic and/or the state themselves.

In some embodiments, an application may interact with a smart contract on the distributed ledger 100. For instance, a cryptocurrency wallet application 120 may contact the node A to initiate a transaction via the smart contract copy 110A. Such a transaction may be propagated through the network, for example, to the node B. The nodes A and B may independently execute the transaction, thereby updating the smart contract copies 110A and 110B, as described above. (Although not shown in FIG. 1, one or more nodes in addition to, or instead of, the nodes A and B may maintain respective copies of the smart contract.)

In some embodiments, the smart contract may include program logic that implements one or more rules to be enforced. For instance, the program logic may include a multi-signature rule, which may indicate that public keys of M public-private key pairs are registered with the smart contract, and that a transaction should be signed with at least N out of the M corresponding private keys, where N≤M.

Additionally, or alternatively, the program logic of the smart contract may include multiple rules corresponding, respectively, to multiple types of actions. As an example, the program logic may include a transaction initiation rule, which may indicate that a transaction should be signed by a private key (of a public-private key pair) that has a designated role of an initiation key. As another example, the program logic may include a transaction approval rule, which may indicate that a transaction should be signed by a private key (of a public-private key pair) that has a designated role of an approval key. As yet another example, the program logic may include a key recovery rule, which may indicate that a request to replace an existing initiation/approval key with a new initiation/approval key should be signed by a private key (of a public-private key pair) that has a designated role of a recovery key. Any suitable rule or combination of rules may be enforced, as aspects of the present disclosure are not so limited.

In some embodiments, the program logic of the smart contract may include a rule that is based on a transaction amount. For instance, the program logic may include a multi-signature trigger rule, which may indicate that the illustrative multi-signature rule described above is triggered if a transaction amount is above a selected threshold. Thus, if an amount of a transaction is below the selected threshold, the transaction may be signed with just one of the M private keys.

Additionally, or alternatively, the program logic of the smart contract may include a transaction approval trigger rule, which may indicate that the illustrative transaction approval rule described above is triggered if a transaction amount is above a selected threshold. Thus, if an amount of a transaction is below the selected threshold, the transaction may be signed with just a private key that has a designated role of an initiation key, without being signed by a private key that has a designated role of an approval key.

In some embodiments, the program logic of the smart contract may include a rule that is based on an aggregate transaction amount over a selected period of time. For instance, such a rule may indicate that a transaction should be declined if the transaction would have resulted in an aggregate transaction amount that is above a selected threshold, where the aggregate transaction amount is determined over a selected period of time. In some embodiments, the aggregate transaction amount may be determined by aggregating all outgoing transactions over the selected period of time. Additionally, or alternatively, the aggregate transaction amount may be determined by aggregating all incoming and outgoing transactions over the selected period of time, so that the aggregate transaction amount may represent a net outgoing amount.

In some embodiments, the program logic of the smart contract may include a rule that is based on a TO address of a transaction. As an example, the program logic may include a blacklist rule, which may indicate that the illustrative multi-signature (or transaction approval) rule described above is triggered if a TO address of a transaction is on a blacklist of one or more distributed ledger addresses. Thus, if a TO address of a transaction is not on the blacklist, the transaction may be signed with just one of the M private keys (or just an initiation key).

As another example, the program logic of the smart contract may include a whitelist rule, which may indicate that the illustrative multi-signature (or transaction approval) rule described above is triggered if a TO address of a transaction is not on a whitelist of one or more distributed ledger addresses. Thus, if a TO address of a transaction is on the whitelist, the transaction may be signed with just one of the M private keys (or just an initiation key).

While details of implementation are described above in connection with FIG. 1, it should be appreciated that such details are provided solely for purposes of illustration. The techniques introduced above and/or discussed in detail below are not limited to any particular manner of implementation. For instance, the wallet application 120 may be provided in any suitable manner. In some embodiments, a wallet application may be hosted by an owner of cryptocurrency assets (e.g., on a user device). Additionally, or alternatively, a wallet application may be hosted by a third party service (e.g., on a cloud computing server).

Moreover, although examples are provided above that relate to cryptocurrency transactions, it should be appreciated that aspects of the present disclosure are not so limited. The techniques described herein may be used in any other application, such as supply chain data management, healthcare data management, etc.

As discussed above, many distributed ledger implementations have scalability challenges. For instance, it may be computationally intensive (e.g., in terms of message, time, and/or space) to validate every transaction, and/or to ensure consistency across all nodes in a network that collectively maintains a distributed ledger. As a result, a number of transactions that the network is able to process per unit of time may be limited. Such challenges have prompted development of layer 2 technologies, which provide improved scalability over underlying distributed ledger technologies.

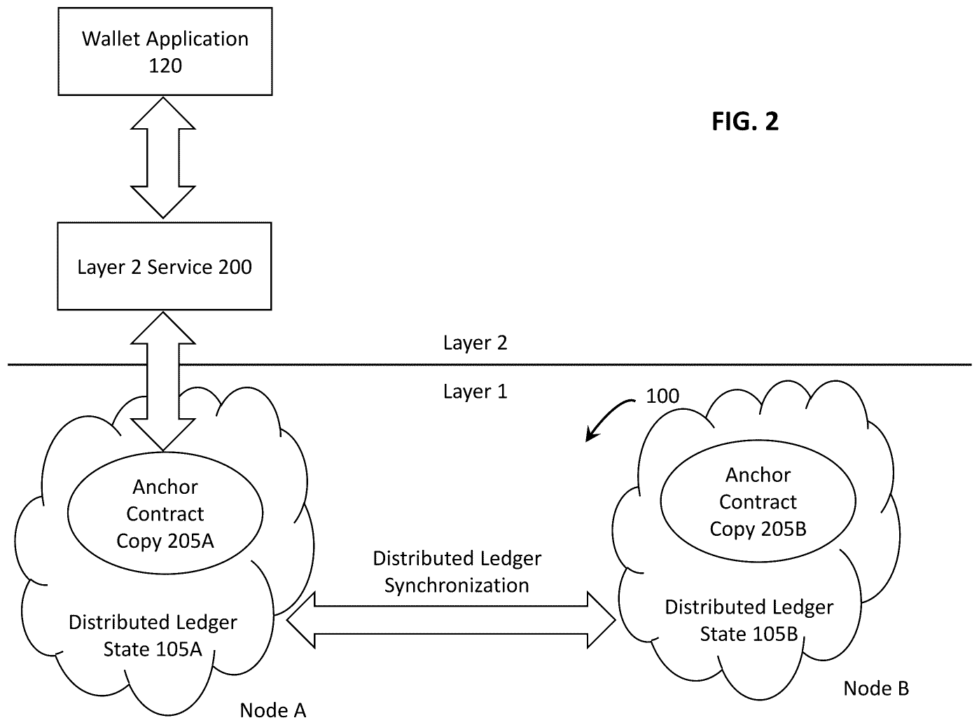

FIG. 2 shows an illustrative layer 2 service 200, in accordance with some embodiments. The layer 2 service 200 may serve as an intermediary between an application and an underlying distributed ledger. For instance, to initiate a transaction, the illustrative wallet application 120 in the example of FIG. 1 may contact the layer 2 service 200, instead of a node maintaining the illustrative distributed ledger 100 (e.g., the node A).

To increase transaction rate, the layer 2 service 200 may, in some embodiments, provide batched processing of transactions. For instance, the layer 2 service 200 may receive a plurality of transactions from the wallet application 120 and/or one or more other wallet applications (not shown in FIG. 2). Instead of sending each individual transaction to the distributed ledger 100 for processing, the layer 2 service 200 may send an aggregate transaction that represents the plurality of transactions executed in a selected order.

In some embodiments, the layer 2 service 200 may be associated with one or more smart contracts, where each smart contract may have a respective address on the distributed ledger 100. For instance, the layer 2 service 200 may maintain respective program logic and/or state(s) of the one or more smart contracts. This information may be referred to herein as a state of the layer 2 service 200, and each of the one or more smart contracts may be referred to herein as a member contract of the layer 2 service 200.

In the example of FIG. 2, the layer 2 service 200 interacts with a smart contract on the distributed ledger 100. This smart contract may be referred to herein as an anchor contract. For instance, the layer 2 service 200 may contact the node A to initiate an aggregate transaction via an anchor contract copy 205A. The aggregate transaction may be propagated through the network, for example, to the node B, which may maintain an anchor contract copy 205B. The nodes A and B may independently execute the aggregate transaction, thereby updating the anchor contract copies 205A and 205B. (Although not shown in FIG. 2, one or more nodes in addition to, or instead of, the nodes A and B may maintain respective copies of the anchor contract.)

In some embodiments, a state of the anchor contract may include a representation of the state of the layer 2 service 200. For instance, a hash tree (e.g., a Merkle tree) may be constructed based on the state of the layer 2 service 200, and a root hash may be stored in each of the anchor contract copies 205A and 205B.

In some embodiments, when a plurality of transactions are executed in a selected order, each transaction may lead to state change(s) for one or more member contracts of the layer 2 service 200. Thus, the batch of transactions (e.g., the plurality of transactions executed in the selected order) may lead to a cumulative change to the state of the layer 2 service 200.

Accordingly, an aggregate transaction representing the batch of transactions may indicate a pre-state root hash representing a state of the layer 2 service 200 prior to executing the batch of transactions, and/or a post-state root hash representing a state of the layer 2 service 200 after executing the batch of transactions. Additionally, or alternatively, the aggregate transaction may include information regarding transactions in the batch, such as a FROM address, a TO address, and/or an amount of each transaction. A transaction in the batch may be referred to herein as a constituent transaction.

In some embodiments, an aggregate transaction may be signed by the layer 2 service 200. Upon receiving the aggregate transaction, each node maintaining a copy of the anchor contract may verify the layer 2 service 200's signature. Additionally, or alternatively, each node may check if a pre-state root hash in the aggregate transaction matches a current state of the anchor contract. If the layer 2 service 200's signature is successfully verified, and/or the pre-state root hash in the aggregate transaction matches the current state of the anchor contract, the state of the anchor contract may be updated with the post-state root hash in the aggregate transaction.

Various techniques may be used to provide correctness of post-state root hashes. For instance, an optimistic rollup technique may be used, where the anchor contract may include program logic to revert a batch and/or one or more subsequent batches if it is determined that the batch's post-state root hash is incorrect. Additionally, or alternatively, a zero-knowledge (ZK) rollup technique may be used, where an aggregate transaction may include a zero-knowledge proof that a post-state root hash in the aggregate transaction is correct. Such a zero-knowledge proof may be efficiently verified by a node maintaining the anchor contract. However, it should be appreciated that aspects of the present disclosure are not limited to using any particular rollup technique, or any rollup technique at all.

The inventors have recognized and appreciated that, because an aggregate transaction is validated via the anchor contract, as opposed to any member contract of the layer 2 service 200, it may be unnecessary to deploy a member contract on the distributed ledger 100. For instance, even if a member contract is not yet deployed on the distributed ledger 100, an aggregate transaction may include a constituent transaction involving the member contract, if an address where the member contract would be deployed on the distributed ledger 100 is known. Such an address may be referred to herein as a layer 1 address of the member contract.

However, the inventors have also recognized and appreciated that, when a constituent transaction involving a member contract is processed as part of an aggregate transaction, there may be insufficient enforcement of one or more rules of the member contract (e.g., a multi-signature rule, a transaction initiation rule, a transaction approval rule, a key recovery rule, a transaction amount rule, an aggregate amount rule, a blacklist rule, a whitelist rule, etc.). For instance, although the layer 2 service 200 may purport to validate the constituent transaction by applying the one or more rules of the member contract, it may be undesirable to rely on a single entity for such validation.

Accordingly, in some embodiments, a service independent of the layer 2 service 200 may be provided to validate a transaction involving a member contract of the layer 2 service 200. For instance, the independent service may use program logic and/or a state of the member contract to validate a proposed transaction involving the member contract. Additionally, or alternatively, the layer 2 service 200 may be configured to process the transaction only if the transaction has been validated by the independent service.

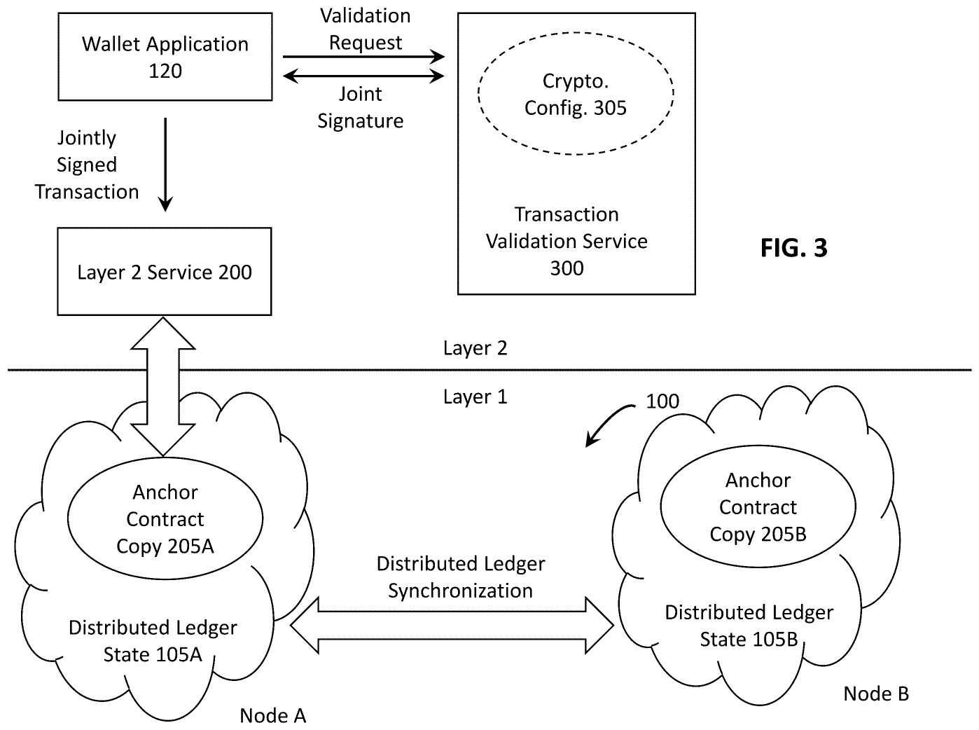

FIG. 3 shows an illustrative transaction validation service 300, in accordance with some embodiments. For instance, prior to sending a transaction to the illustrative layer 2 service 200 in the example of FIG. 2, the illustrative wallet application 120 in the example of FIG. 1 may send a request to the transaction validation service 300 to validate the transaction.

In some embodiments, the transaction validation service 300 may maintain a cryptographic configuration 305, which may include a copy of a member contract of the layer 2 service 200 (e.g., a signed transaction for deploying the member contract). For instance, the cryptographic configuration 305 may include program logic and/or a state of the member contract, which may be used by the transaction validation service 300 to validate a proposed transaction involving the member contract.

In some embodiments, the member contract may not be deployed on the illustrative distributed ledger 100 in the example of FIG. 1. Instead, a layer 1 address for the member contract may be obtained, without actual deployment. For instance, the distributed ledger 100 may be an Ethereum blockchain, and a CREATE2 opcode (instead of CREATE) may be used to obtain a layer 1 address.

In some embodiments, a layer 1 address may be obtained based on a creator address, which may be an address of a factory contract. Additionally, or alternatively, the layer 1 address may be obtained based on creation code for the member contract. The creation code may include a contract constructor, one or more arguments to the contract constructor, and/or code of the member contract. A hash may be computed from the creation code, and may be used in obtaining the layer 1 address.

Additionally, or alternatively, the layer 1 address may be obtained based on a salt value, which may be determined based on a configuration of the member contract (e.g., an initial configuration of the member contract). As an example, if the member contract includes an N-out-of-M multi-signature rule, the salt value may be determined based on M public keys that are to be registered with the member contract (e.g., via an initialization transaction). As another example, if the member contract includes a transaction initiation rule, a transaction approval rule, and/or a key recovery rule, the salt value may be determined based on public key(s) corresponding, respectively, to an initiation key, an approval key, and/or a recovery key to be registered with the member contract (e.g., via an initialization transaction).

It should be appreciated that a public key may be a cryptographic public key, or a value derived from a cryptographic public key. For instance, in Ethereum, a public address may be computed from a cryptographic public key by hashing the cryptographic public key and truncating a resulting hash to the least significant 20 bytes. Such a public address may be an example of a public key.

It should also be appreciated that aspects of the present disclosure are not limited to determining a salt value in any particular manner. In some embodiments, a salt value may be determined by hashing an initialization transaction for a member contract, which may indicate a transaction initiation rule, a transaction approval rule, a key recovery rule, and/or one or more other suitable rules, and/or one or more corresponding public keys.

The inventors have recognized and appreciated that it may be desirable to obtain a layer 1 address for a member contract, without deploying the member contract on the distributed ledger 100. For instance, actually deploying a member contract may involve a transaction on the distributed ledger 100, which may in turn involve a significant amount of computation by one or more nodes that maintain the distributed ledger 100. By avoiding and/or delaying deployment, such computation may be avoided and/or delayed.

However, it should be appreciated that aspects of the present disclosure are not limited to avoiding or delaying deployment of a member contract. In some embodiments, the layer 2 service 200 may process transactions involving one or more member contracts that are deployed on the distributed ledger 100.

It also should be appreciated that aspects of the present disclosure are not limited to maintaining program logic and/or a state of a member contract of the layer 2 service 200, or any smart contract at all. In some embodiments, the cryptographic configuration 305 may include program logic and/or a state of a party participating in a multi-party computation (MPC) protocol.

Moreover, although the inventors have recognized and appreciated various benefits of having a transaction validation service that is independent of a layer 2 service, it should be appreciated that aspects of the present disclosure are not so limited. In some embodiments, one or more of the functionalities of the transaction validation service 300 may additionally, or alternatively, be performed by the layer 2 service 200.

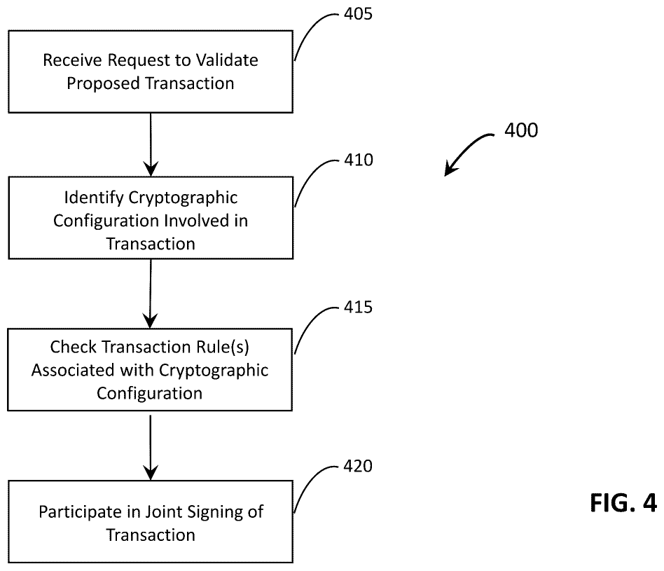

FIG. 4 shows an illustrative process 400 for validating a transaction, in accordance with some embodiments. For instance, the process 400 may be performed by the illustrative transaction validation service 300 in the example of FIG. 3 to validate a proposed transaction received from the illustrative wallet application 120 in the example of FIG. 1.

At act 405, the transaction validation service 300 may receive a request to validate a transaction. For example, the request may be received from the wallet application 120, and may include a transaction to be submitted to the illustrative layer 2 service 200 in the example of FIG. 2 for processing.

At act 410, the transaction validation service 300 may identify a cryptographic configuration involved in the transaction received at act 405. For instance, the transaction received at act 405 may indicate a layer 1 address of a member contract of the layer 2 service 200, and the transaction validation service 300 may use the layer 1 address to identify the illustrative cryptographic configuration 305 in the example of FIG. 3, which may include a copy of the member contract.

At act 415, the transaction validation service 300 may check one or more transaction rules associated with the cryptographic configuration identified at act 410. For instance, the cryptographic configuration identified at act 410 may include program logic and/or a state of the member contract. The program logic may implement one or more transaction rules, such as an N-out-of-M multi-signature rule, a transaction initiation rule, a transaction approval rule, a transaction amount rule, an aggregate amount rule, a blacklist rule, a whitelist rule, etc.

In some embodiments, the transaction validation service 300 may apply the program logic to the transaction. For instance, if a rule indicates the transaction should be signed with a certain private key, the program logic may include logic to use a corresponding public key to verify a signature on the transaction. Additionally, or alternatively, the program logic may include logic to compute a new aggregate amount from an existing aggregate amount and a proposed transaction amount, and/or to compare the new aggregate amount against a certain threshold amount.

Thus, applying the program logic to the transaction may be based on the state of the member contract, such as a public key, an existing aggregate amount, a threshold amount, etc. stored in the state of the member contract. Additionally, or alternatively, the transaction validation service 300 may update the state of the member contract, as a result of applying the program logic to the transaction, for example, by replacing the existing aggregate amount with a new aggregate amount.

It should be appreciated that aspects of the present disclosure are not limited to maintaining any particular type of state information, or any state information at all. In some embodiments, relevant state information (e.g., an existing aggregate amount) may be retrieved from the layer 2 service 200. Additionally, or alternatively, such state information may be derived using transaction history retrieved from the layer 2 service 200.

At act 420, if the transaction validation service 300 successfully checks the transaction against the one or more transaction rules at act 415, the transaction validation service 300 may sign the transaction with a private key maintained by the transaction validation service 300. For instance, when the cryptographic configuration is registered with the transaction validation service 300, a public-private key pair may be established. The private key of that key pair may be maintained by the transaction validation service 300 for use in signing validated transactions for the cryptographic configuration. Such a private key may be referred to herein as a validation key.

In some embodiments, the transaction validation service 300 may return the signature generated at act 420 to the wallet application 120. Additionally, or alternatively, the transaction validation service 300 may, at act 420, jointly sign the transaction with the wallet application 120. For instance, the transaction validation service 300 may sign using a validation key, whereas the wallet application 120 may sign using a user key, which may be a private key of another public-private key pair associated with the cryptographic configuration, and may be maintained by the wallet application 120. It should be appreciated that the user key and the validation key may be different from a transaction initiation key and a transaction approval key of the member contract.

In some embodiments, a 2-out-of-2 multi-signature technique may be used. Thus, to be verified successfully, a signature should be generated using both the user key and the validation key. Verification may be performed using an aggregate public key, which may be obtained from the public keys corresponding, respectively, to the user key and the validation key.

In some embodiments, a Schnorr multi-signature technique may be used. However, it should be appreciated that aspects of the present disclosure are not limited to using any particular multi-signature technique, or any multi-signature technique at all. In some embodiments, the wallet application 120 and the layer 2 service 200 may generate separate signatures, which may be used in addition to, or instead of, a jointly generated signature.

Referring again to the example of FIG. 3, the wallet application 120 may send the transaction to the layer 2 service 200 for processing, along with the joint signature generated by the wallet application 120 and the transaction validation service 300. The layer 2 service 200 may verify the joint signature using the aggregate public key, which may be provided to the layer 2 service 200 when the cryptographic configuration is registered with the layer 2 service 200. If the joint signature is successfully verified, the layer 2 service 200 may process the transaction, for example, as a constituent transaction of a batch of transactions.

Although details of implementation are described above in connection with FIGS. 2-4, it should be appreciated that such details are provided solely for purposes of illustration. The techniques introduced above and/or discussed in detail below are not limited to any particular manner of implementation. For instance, in some embodiments, the transaction validation service 300 may serve as an intermediary between the wallet application 120 and the layer 2 service 200. Accordingly, the transaction validation service 300 may send the signature generated at act 420 to the layer 2 service 200, along with the proposed transaction received from the wallet application 120. In this manner, transaction validation and/or layer 2 processing may be transparent to the wallet application 120

Additionally, or alternatively, a request to the transaction validation service 300 to validate a transaction may be sent by the layer 2 service 200, as opposed to the wallet application 120. Accordingly, the transaction validation service 300 may send the signature generated at act 420 to the layer 2 service 200, as opposed to the wallet application 120.

As described above in connection with the example of FIG. 3, a layer 1 address of a member contract may be obtained based on a creator address, creation code for the member contract, and/or a salt value. In some embodiments, the salt value may be determined based on the illustrative user key and/or the illustrative validation key in the example of FIG. 4.

For instance, the salt value may be determined by hashing the public keys corresponding, respectively, to the user key and the validation key. Additionally, or alternatively, the salt value may be determined by hashing the aggregate public key obtained from the public keys corresponding, respectively, to the user key and the validation key.

Additionally, or alternatively, the salt value may be determined by hashing an initialization transaction for the member contract. For instance, the member contract may have a setup function that may be called with one or more parameter values. Examples of such parameter values include, but are not limited to, a public key (which may be a public address), a role corresponding to the public key (e.g., initiation, approval, or key recovery), a threshold amount, a whitelist, a blacklist, etc. The one or more parameter values may be hashed, and a resulting hash may be used to determine the salt value.

In some embodiments, the one or more parameter values may be encoded prior to being hashed. For instance, a suitable Application Binary Interface (ABI) encoding may be used. However, it should be appreciated that aspects of the present disclosure are not limited to encoding the one or more parameter values in any particular manner, or at all.

In some embodiments, the one or more parameter values may be hashed, with or without first being encoded, to obtain a first hash. Additionally, or alternatively, the aggregate public key, which may be obtained from the public keys corresponding, respectively, to the user key and the validation key, may be hashed to obtain a second hash. The first and second hashes may be combined in any suitable manner, for example, by hashing a result of concatenating the first and second hashes, to thereby obtain a third hash. The third hash may then be used as the salt value.

Referring again to the example of FIG. 3, the wallet application 120 may provide, to the layer 2 service 200, the salt value used to obtain the layer 1 address of the member contract. This may allow the layer 2 service 200 to check that the layer 1 address of the member contract is indeed obtained based on a creator address, creation code for the member contract, and the salt value (e.g., using the CREATE2 opcode as described above).

Although various examples are provided above, it should be appreciated that aspects of the present disclosure are not limited to computing or using a salt value in any particular manner, or at all.

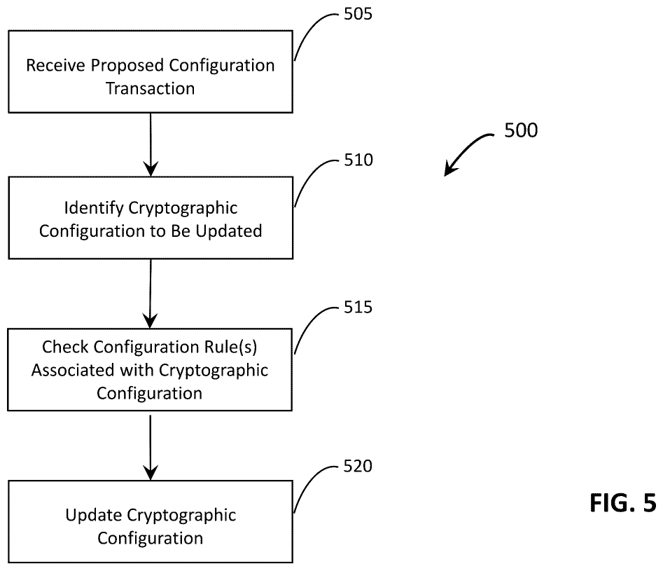

FIG. 5 shows an illustrative process 500 for maintaining a cryptographic configuration, in accordance with some embodiments. For instance, the process 500 may be performed by the illustrative transaction validation service 300 in the example of FIG. 3 to maintain the illustrative cryptographic configuration 305.

At act 505, the transaction validation service 300 may receive a request to update a cryptographic configuration. For instance, the request may be received from the wallet application 120, and may include a configuration transaction for a smart contract.

At act 510, the transaction validation service 300 may identify a cryptographic configuration to which the configuration transaction received at act 505 pertains. For instance, the configuration transaction received at act 505 may indicate a layer 1 address of a member contract of the layer 2 service 200 in the example of FIG. 2. The transaction validation service 300 may use the layer 1 address to identify the cryptographic configuration 305, which may include a copy of the member contract.

At act 515, the transaction validation service 300 may check one or more configuration rules associated with the cryptographic configuration identified at act 510. For instance, the cryptographic configuration identified at act 510 may include program logic and/or a state of the member contract. The program logic may implement one or more configuration rules, such as a key recovery rule.

In some embodiments, the transaction validation service 300 may apply the program logic to the configuration transaction received at act 505. For instance, the configuration transaction may include a request to replace an existing initiation/approval key with a new initiation/approval key, and the key recovery rule may indicate that the configuration transaction should be signed by a private key (of a public-private key pair) that has a designated role of a recovery key. Accordingly, the program logic may include logic to use a public key corresponding to the recovery key to verify a signature on the configuration transaction.

At act 520, if the transaction validation service 300 successfully checks the one or more configuration rules against the configuration transaction at act 515, the transaction validation service 300 may update the cryptographic configuration. For instance, a current state of the member contact may store a first public key corresponding to the existing initiation/approval key, and the configuration transaction may indicate a second public key corresponding to the new initiation/approval key. The transaction validation service 300 may replace the first public key with the second public key, thereby updating the state of the member contract.

As discussed above, the inventors have recognized and appreciated that it may be desirable to allow the illustrative layer 2 service 200 in the example of FIG. 2 to process transactions involving one or more member contracts that are not deployed on the illustrative distributed ledger 100 in the example of FIG. 1. However, the inventors have also recognized and appreciated that, if a member contract is not deployed, a user who owns the member contract may rely on the layer 2 service 200 to be available and to correctly process transactions. Likewise, the user may rely on the illustrative transaction validation service 300 in the example of FIG. 3 to be available and to correctly validate transactions.

Accordingly, in some embodiments, techniques are provided to mitigate such reliance. For instance, a user who owns a member contract of the layer 2 service 200 may be able to deploy the member contract to the distributed ledger 100, thereby becoming independent of the layer 2 service 200 and the transaction validation service 300.

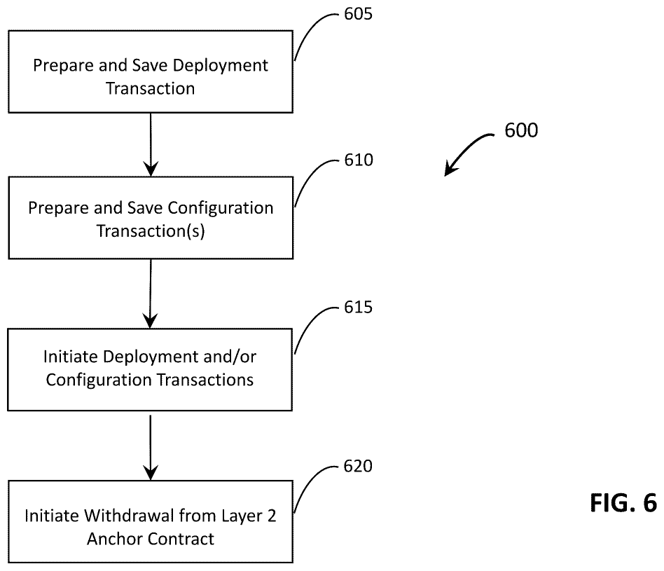

FIG. 6 shows an illustrative process 600 for deploying a cryptographic configuration, in accordance with some embodiments. For instance, the process 600 may be performed by the illustrative wallet application 120 in the example of FIG. 1, or some other suitable application.

At act 605, a deployment transaction may be prepared for a cryptographic configuration to be registered with the layer 2 service 200. For instance, the deployment transaction may be prepared for a member contract, and may indicate a creator address, which may be an address of a factory contract. Additionally, or alternatively, the deployment transaction may include creation code for the member contract, which may in turn include a contract constructor, one or more arguments to the contract constructor, and/or code of the member contract.

In some embodiments, instead of being sent to the factory contract for processing, the deployment transaction may simply be saved. Additionally, or alternatively, the deployment transaction may be sent to the layer 2 service 200 and/or the transaction validation service 300. For instance, as described above in connection with the example of FIG. 3, a layer 1 address may be obtained for the member contract, and may be used to register the member contract with the layer 2 service 200 and/or the transaction validation service 300. The transaction validation service 300 may validate transactions involving the member contract, and/or the layer 2 service 200 may process such transactions, without the member contract being deployed on the distributed ledger 100.

At act 610, one or more configuration transactions may be prepared for the member contract. For instance, an initialization transaction may be prepared, which may indicate an initial configuration of the member contract, such as one or more public keys to be registered with the member contract initially.

Additionally, or alternatively, if an existing initiation/approval key is lost or compromised, a configuration transaction may be prepared, which may include a request to replace the existing initiation/approval key with a new initiation/approval key.

In some embodiments, like the deployment transaction prepared at act 605, the one or more configuration transactions prepared at act 610 may be saved. Additionally, or alternatively, the one or more configuration transactions may be sent to the transaction validation service 300, which may use the one or more configuration transactions to update the cryptographic configuration (e.g., as described above in connection with the example of FIG. 5).

At act 615, a user who owns the member contract may decide to become independent of the layer 2 service 200 and the transaction validation service 300. Accordingly, the deployment transaction saved at act 605 may be sent to the factory contract, which may process the deployment transaction, thereby deploying the member contract on the distributed ledger 100 at the layer 1 address obtained at act 605.

Additionally, or alternatively, once the member contract is deployed on the distributed ledger 100, the one or more configuration transactions saved at act 610 may be sent to the member contract. The member contract may process the one or more configuration transactions (e.g., in an order in which the one or more configuration transactions are saved), thereby bringing a configuration of the member contract up to date.

At act 620, a withdrawal transaction may be prepared and sent to an anchor contract of the layer 2 service 200 (e.g., the anchor contract copy 205A or 205B in the example of FIG. 2). The withdrawal transaction may indicate the layer 1 address of the member contract. The anchor contract may process the withdrawal transaction, thereby transferring to the member contract one or more digital assets that the layer 2 service 200 has been managing for the member contract.

The inventors have recognized and appreciated that, in some instances, the illustrative wallet application 120 in the example of FIG. 1 may be hosted by a third party service (e.g., on a cloud computing server). Thus, prior to sending a transaction (e.g., an outgoing transaction) involving a cryptographic configuration to the illustrative distributed ledger 100 (or the illustrative layer 2 service 200 in the example of FIG. 2), the wallet application 120 may request authorization from a user who owns the smart contract.

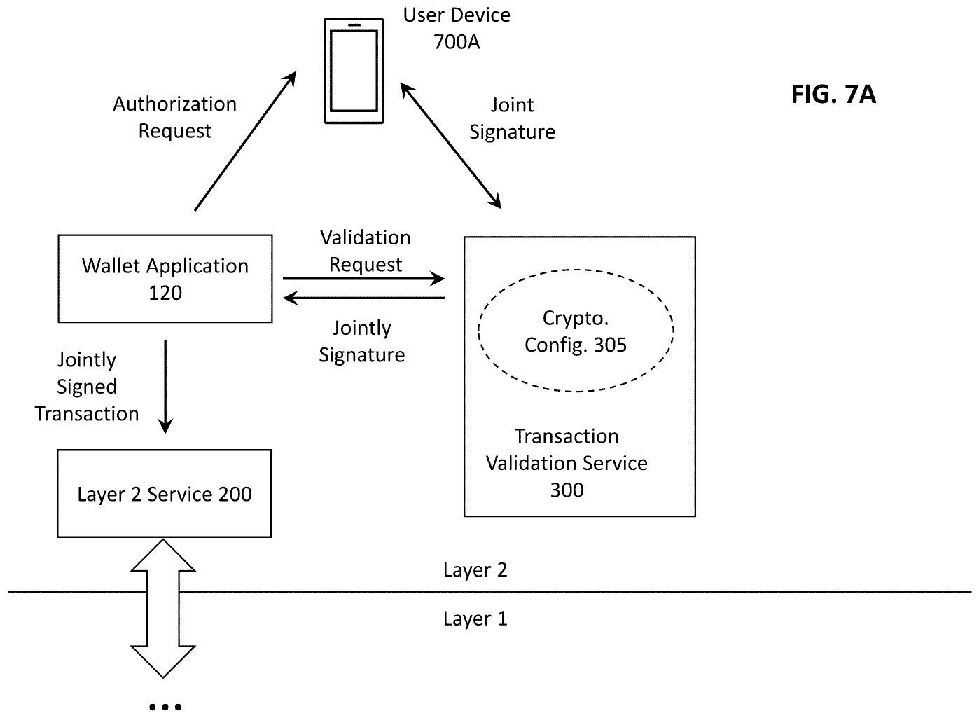

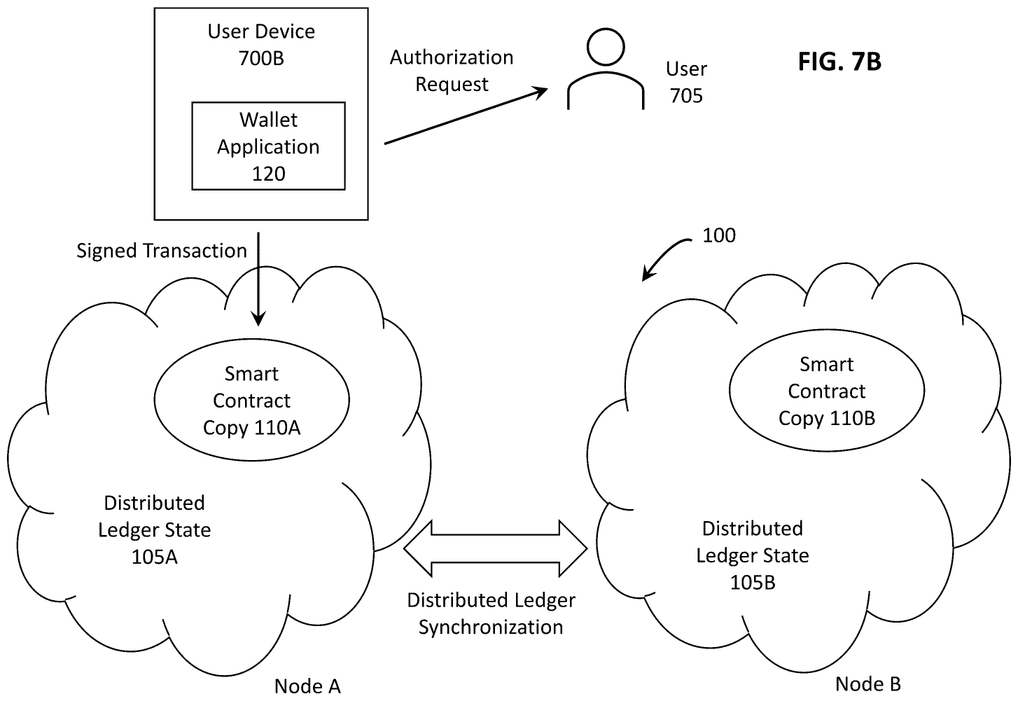

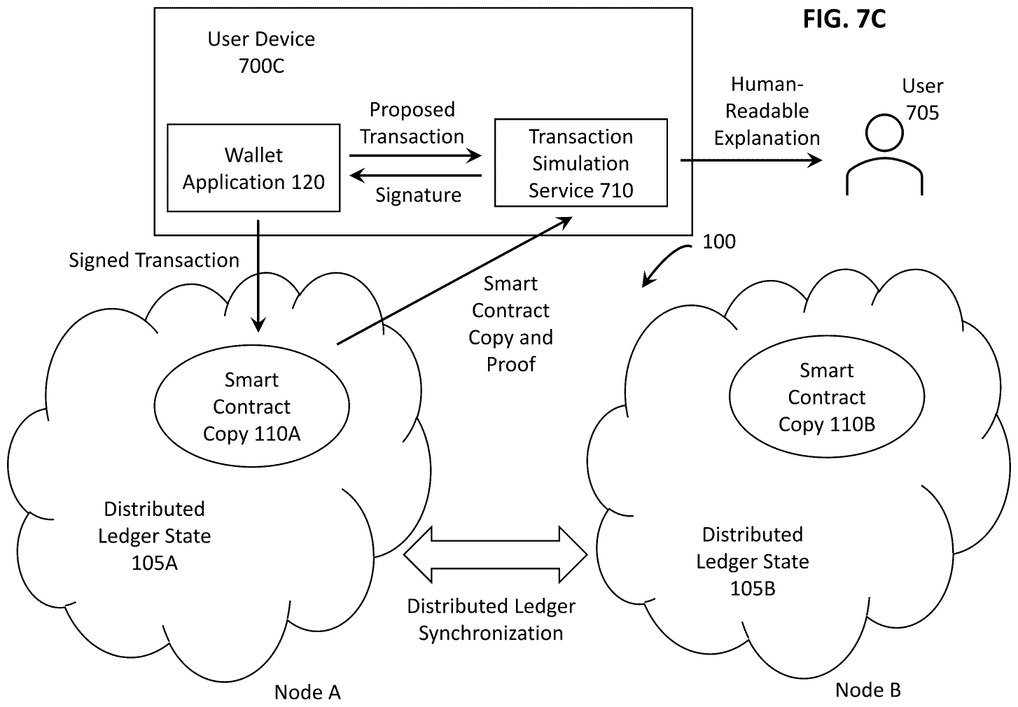

FIG. 7A shows an illustrative user device 700A, in accordance with some embodiments. For instance, the user device 700A may store a user key associated with a cryptographic configuration, such as the illustrative user key described in connection with the example of FIG. 4.

In some embodiments, prior to sending a transaction to the layer 2 service 200, the wallet application 120 may send an authorization request to the user device 700A. This may be done in addition to, or instead of, sending a request to the illustrative transaction validation service 300 in the example of FIG. 3 to validate the transaction.

In some embodiments, if the transaction validation service 300 successfully validates the transaction, and if the transaction is authorized by a user, the transaction validation service 300 may jointly sign the transaction with the user device 700A (instead of, or in addition to, jointly signing with the wallet application 120, as described in connection with the example of FIG. 4). For instance, the transaction validation service 300 may sign using a validation key, whereas the user device 700A may sign using the user key. The transaction validation service 300 may then return the joint signature to the wallet application 120, which may forward the joint signature to the layer 2 service 200.

Although details of implementation are described above in connection with FIGS. 5-7A, it should be appreciated that such details are provided solely for purposes of illustration. The techniques introduced above and/or discussed in detail below are not limited to any particular manner of implementation. For instance, in some embodiments, the signature jointly generated by the transaction validation service 300 and the user device 700A may be sent to the wallet application 120 by the user device 700A, in addition to, or instead of, the transaction validation service 300.

Moreover, it should be appreciated that the user device 700A may be any suitable device that is configured to participate in signing using the user key. For instance, the user device 700A may be a general-purpose computing device (e.g., a desktop computer, a laptop computer, a smartphone, etc.), or specialized cryptographic hardware.

FIG. 7B shows an illustrative user device 700B, in accordance with some embodiments. For instance, the illustrative wallet application 120 in the example of FIG. 1 may be hosted on the user device 700A. Additionally, or alternatively, the user device 700B may store one or more keys associated with a cryptographic configuration. For instance, the cryptographic configuration may include the illustrative smart contract copy 110A, and the one or more keys may include a transaction initiation key, a transaction approval key, a recovery key, etc.

In some embodiments, the wallet application 120 may prompt a user 705 to authorize a proposed transaction, prior to sending the transaction to the smart contract copy 110A for processing. In response to the user 705 authorizing the transaction, the wallet application 120 may use the one or more keys to sign the transaction, and may send the signed transaction to the smart contract copy 110A.

The inventors have recognized and appreciated that a data structure over which the signature is generated may not be human readable, or at least not easily understood by a user who is not trained as a software engineer. As a result, the user 705 may rely on the wallet application 120 to provide a human-understandable explanation of the transaction (e.g., FROM address, TO address, digital asset type, transaction amount, etc.).

The inventors have recognized and appreciated that such reliance may be undesirable. For instance, if the wallet application 120 becomes compromised, the wallet application 120 may provide an incorrect explanation to induce the user 705 to authorize a transaction that the user 705 does not intend to authorize.

Accordingly, in some embodiments, a proposed transaction from the wallet application 120 may be independently analyzed, and a human-understandable explanation may be independently provided to the user 705. In this manner, the user 705 may be able to confirm that the explanation provided by the wallet application 120 is indeed correct.

FIG. 7C shows an illustrative user device 700C, in accordance with some embodiments. For instance, the user device 700C may host the illustrative wallet application 120 in the example of FIG. 1, as well as a transaction simulation service 710. In some embodiments, the transaction simulation service 710 may be the illustrative transaction validation service 300 in the example of FIG. 3.

In some embodiments, the wallet application 120 may, prior to sending a proposed transaction to the smart contract copy 110A for processing, send the transaction to the transaction simulation service 710. In response, the transaction simulation service 710 may provide a human-understandable explanation of the transaction to the user 705. Such a human-understandable explanation may be generated in any suitable manner. For instance, the transaction simulation service 710 may extract basic information from the transaction (e.g., FROM address, TO address, digital asset type, transaction amount, etc.), and may provide a human-understandable explanation relating thereto.

Additionally, or alternatively, the transaction simulation service 710 may analyze one or more values relating to the transaction, and may determine if the one or more values are as expected. As an example, the transaction may have a fee attribute, and the transaction simulation service 710 may check if a fee value is within a selected range, which may depend on a transaction amount. As another example, the transaction may have a nonce attribute, and the transaction simulation service 710 may check if a nonce value, which may indicate a number of transactions sent from a FROM address, satisfies one or more rules for validating the transaction.

Additionally, or alternatively, the transaction simulation service 710 may simulate the transaction. For instance, the transaction simulation service 710 may access, from the distributed ledger 100, a cryptographic configuration involved in the transaction. The transaction simulation service 710 may verify the received cryptographic configuration, for example, by requesting a proof (e.g., a Merkle proof) from the distributed ledger 100, and then checking the proof.

In some embodiments, if the received cryptographic configuration is successfully verified, the transaction simulation service 710 may use the received cryptographic configuration to simulate the transaction. For instance, the cryptographic configuration may include program logic and/or a current state of a smart contract (e.g., the smart contract copy 110A). The program logic may be executed based on the current state, thereby obtaining a new state that would have resulted if the transaction had actually been processed by the distributed ledger 100. The new state may then be analyzed to determine a human-understandable explanation (e.g., a remaining balance at the FROM address).

It should be appreciated that the transaction may be simulated in any suitable manner, for instance, using a local virtual machine (e.g., an Ethereum virtual machine). The virtual machine may be configured to process the transaction in a similar way as a node in the network of nodes managing the distributed ledger 100 (e.g., the illustrative node A or node B in the example of FIG. 1).

In some embodiments, the transaction simulation service 710 may detect, through simulation, one or more events that may result from the transaction. For instance, the transaction simulation service 710 may track one or more messages that may be produced as a result of the transaction. Such a message, if actually propagated across the distributed ledger 100, may have triggered one or more actions (e.g., transfer of one or more tokens).

Additionally, or alternatively, the transaction simulation service 710 may attempt to match a detected event to an event type. If there is a matching event type, the transaction simulation service 710 may produce a human-understandable explanation based on the event type. Otherwise, the transaction simulation service 710 may simply display the event (e.g., one or more messages representing the event).

In some embodiments, signing of the transaction may be effectuated by the transaction simulation service 710, instead of the wallet application 120. In this manner, the transaction simulation service 710 may ensure that a data structure being signed matches the proposed transaction analyzed by the transaction simulation service 710.

Although details of implementation are described above in connection with FIGS. 7B-C, it should be appreciated that such details are provided solely for purposes of illustration. For instance, in some embodiments, a human-understandable explanation may be provided by a service separate from the illustrative transaction validation service 300 in the example of FIG. 3. Moreover, a human-understandable explanation may be provided for a layer 2 transaction, in addition to, or instead of, a transaction to be submitted directly to the distributed ledger 100.

Furthermore, the inventors have recognized and appreciated that security may be improved by hosting both the wallet application 120 and the transaction simulation service 710 on the same user device. However, aspects of the present disclosure are not so limited. In some embodiments, the wallet application 120 and/or the transaction simulation service 710 may be hosted on a different device, such as a cloud computing server.

Referring again to the example of FIG. 1, the inventors have recognized and appreciated that the illustrative wallet application 120 may manage private keys for multiple distributed ledger addresses for a user. For instance, the user may have different addresses for difference types of transactions (e.g., one or more first addresses for gaming, one or more second addresses for shopping, etc.). The inventors have recognized and appreciated that, if transactions involving these addresses are processed via the same smart contract on the distributed ledger 100, inferences may be drawn by observing publicly available transaction information. For instance, the one or more first addresses and the one or more second addresses may be linked, thereby linking the user's gaming and shopping activities (even though the user's precise identity may not be known).

Accordingly, in some embodiments, the wallet application 120 may send transactions to one or more proxy contracts on the distributed ledger 100, in addition to, or instead of, a main contract. Such a proxy contract may have an address that is different from that of the main contract. Additionally, or alternatively, different proxy contracts may have different addresses. Accordingly, the main contract may not be linked to any proxy contract, and/or any proxy contract may not be linked to any other proxy contract. In this manner, if separate proxy contracts are used for respective types of transactions (e.g., gaming, shopping, etc.), different activities of the user may not be linked.

However, the inventors have also recognized and appreciated that it may be burdensome and/or costly to deploy and configure multiple proxy contracts, especially if the user desires to enforce one or more transaction rules such as an N-out-of-M multi-signature rule, a transaction initiation rule, a transaction approval rule, a transaction amount rule, an aggregate amount rule, a blacklist rule, a whitelist rule, etc. Accordingly, in some embodiments, a privacy service may be provided to enforce one or more transaction rules.

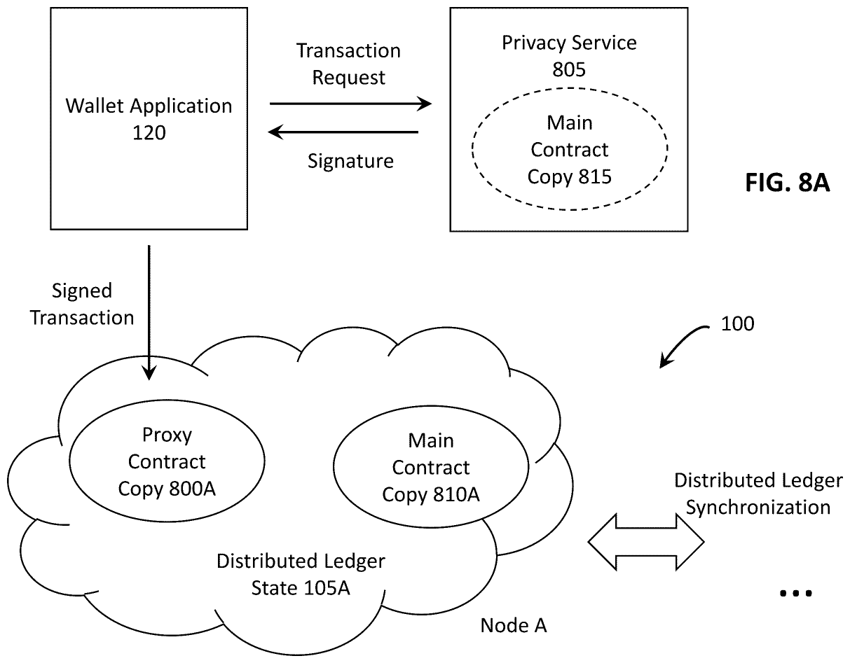

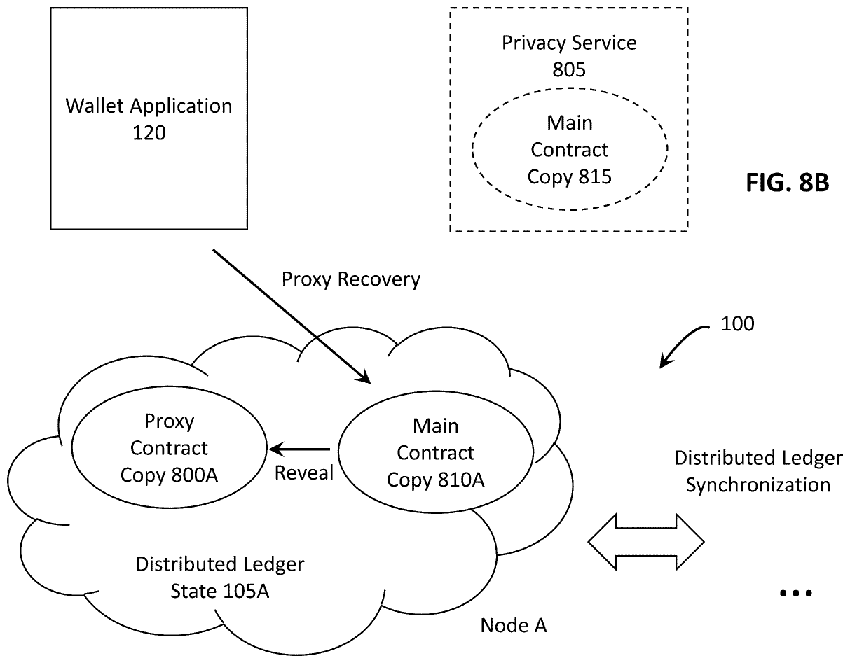

FIG. 8A shows an illustrative proxy contract copy 800A and an illustrative privacy service 805, in accordance with some embodiments. In this example, the proxy contract copy 800A is a copy of a proxy contract, and is maintained by the illustrative node A in the example of FIG. 1. Although not shown in FIG. 8A, one or more copies of the proxy contract may be maintained, respectively, by one or more nodes in addition to, or instead of, the node A.

In some embodiments, prior to sending a transaction to the distributed ledger 100, the wallet application 120 may send a request to the privacy service 805 to validate the transaction. In response to successfully validating the transaction, the privacy service 805 may generate one or more signatures over the transaction, and may send the one or more signatures to the wallet application 120. In turn, the wallet application 120 may forward the transaction, along with the one or more signatures generated by the privacy service 805, to the proxy contract copy 800A for processing.

In some embodiments, the proxy contract copy 800A may include program logic, such as a transaction initiation rule and a transaction approval rule (e.g., as described above in connection with the example of FIG. 1). An initiation key associated with the transaction initiation rule of the proxy contract copy 800A may be used by the wallet application 120 to sign a proposed transaction. Such an initiation key may be referred to herein as a user proxy key.

Additionally, or alternatively, an approval key associated with the transaction approval rule of the proxy contract copy 800A may be used by the privacy service 805 to sign a proposed transaction that has been successfully validated. Such an approval key may be referred to herein as a privacy service key.

Referring again to the example of FIG. 8A, the wallet application 120 may be associated with a main contract. A copy 810A of the main contract may be maintained by the node A. Although not shown in FIG. 8A, one or more copies of the main contract may be maintained, respectively, by one or more nodes in addition to, or instead of, the node A.

In some embodiments, upon receiving a request from the wallet application 120 to validate a proposed transaction, the privacy service 805 may determine that the transaction is to be processed by the proxy contract. Additionally, or alternatively, the privacy service 805 may map the proxy contract to the main contract associated with the wallet application 120.

For instance, the transaction may include a layer 1 address of the proxy contract. The privacy service 805 may map the layer 1 address of the proxy contract to a layer 1 address of the main contract (e.g., using a lookup table, and/or some other suitable data structure).

In some embodiments, the privacy service 805 may maintain a copy 815 of the main contract, which may include program logic and/or a state of the main contract. Additionally, or alternatively, the privacy service 805 may use the layer 1 address of the main contract to access the program logic and/or the state of the main contract from the distributed ledger 100.

In some embodiments, the privacy service 805 may use the program logic and/or the state of the main contract to validate the transaction received from the wallet application 120. Such validation may be performed in any suitable manner, for instance, as described above in connection with act 415 in the example of FIG. 4. In response to successfully validating the transaction, the privacy service 805 may sign the validated transaction using the privacy service key.

Additionally, or alternatively, the privacy service 805 may send the signature generated using the privacy service key to the wallet application 120. In turn, the wallet application 120 may forward the transaction to the proxy contract copy 800A, along with the signature received from the privacy service and/or a signature generated by the wallet application 120 over the transaction using the user proxy key.

It should be appreciated that aspects of the present disclosure are not limited to the wallet application 120 sending a transaction to the proxy contract copy 800A with one or more appropriate signatures. In some embodiments, the wallet application 120 may send a transaction to the privacy service 850, along with a signature generated by the wallet application 120 over the transaction using the user proxy key. In response to successfully validating the transaction, the privacy service 805 may generate a signature over the transaction using the privacy service key, and may send the transaction to the proxy contract copy 800A with both signatures.

Additionally, or alternatively, in response to successfully validating the transaction, the privacy service 805 may cooperate with the wallet application 120 to jointly signed the transaction (e.g., using a Schnorr multi-signature technique, and/or some other suitable multi-signature technique).

Furthermore, it should be appreciated that aspects of the present disclosure are not limited to having a proxy contract or a main contract that is deployed on the distributed ledger 100. In some embodiments, a proxy contract and/or a main contract may be member contract(s) of the illustrative layer 2 service 200 in the example of FIG. 3. The privacy service 805 may maintain a copy of the proxy contract, and/or a copy of the main contract, using a process that is similar to the illustrative process 500 in the example of FIG. 5. A deployment transaction for the proxy contract and/or a deployment transaction for the main contract may be prepared and saved, and the proxy contract and/or the main contract may be deployed only as needed, as described in connection the example of FIG. 6.

Further still, it should be appreciated that aspects of the present disclosure are not limited to having any smart contract at all. In some embodiments, one or more proxy contract and/or a main contract may be replaced with one or more MPC configurations. For instance, an MPC configuration may be provided with multiple user proxy key shares and at least one privacy service key share, where at least one user proxy key share and at least one privacy service key share may be used to process a transaction. In this manner, if one user proxy key share is lost, another user proxy key share may be used instead.

While the illustrative proxy contract copy 800A and the illustrative privacy service 805 in the example of FIG. 8A may be used to improve privacy, the inventors have recognized and appreciated that it may be undesirable to rely on a single entity (i.e., the privacy service 805) to enforce one or more rules of the main contract. For instance, the privacy service 805 may become unavailable, or even compromised. Accordingly, in some embodiments, techniques are provided to mitigate such reliance.

FIG. 8B shows the illustrative wallet application 120 sending a transaction directly to the main contract copy 810A in the example of FIG. 8A, in accordance with some embodiments. For instance, the wallet application 120 may do so if the privacy service 805 becomes unavailable or compromised, or if the wallet application 120 loses the user proxy key.

In some embodiments, a salt value may be selected when the proxy contract is set up. A proof may be generated based on the salt value and/or the layer 1 address of the main contract. For example, the salt value and the layer 1 address of the main contract may be combined in a suitable manner (e.g., concatenated in a selected order), and then hashed to generate a salted hash.

It should be appreciated that the salt value may be selected in any suitable manner. In some embodiments, the salt value may be randomly generated. Additionally, or alternatively, the salt value may be derived from a secret (e.g., one or more private keys), so that a user may not have to memorize or store the salt value.

In some embodiments, a proof (e.g., a salted hash) may be stored in the proxy contract copy 800A, and thus recorded on the distributed ledger 100, whereas the salt value may be stored by the wallet application 120. Thus, in some instances, the wallet application 120 may store different salt values corresponding, respectively, to different proxy contracts.

Accordingly, if the privacy service 805 becomes unavailable or compromised, or if the wallet application 120 loses the user proxy key, the wallet application 120 may send a proxy recovery transaction to the main contract copy 810A. The proxy recovery transaction may include the salt value used to set up the proxy contract. The main contract copy 810A may then send a reveal transaction to the proxy contract copy 800A, where the reveal transaction may include the salt value.

In some embodiments, the proxy contract copy 800A may verify that the salt value received from the main contract copy 810A indeed corresponds to the salted hash stored by the proxy contract copy 800A. For instance, the proxy contract copy 800A may check that a salted hash of the received salt value and/or the layer 1 address of the main contract copy 810A matches the salted hash stored in the proxy contract copy 800A.

If so, the proxy contract copy 800A may take an appropriate remedial action. For instance, if the wallet application 120 has lost the user proxy key, the wallet application 120 may generate a replacement user proxy key, and may include, in the proxy recovery transaction, a public key corresponding to the replacement user proxy key. This public key may be forwarded by the main contract copy 810A to the proxy contract copy 800A. If the salt value is correct, the proxy contract copy 800A may replace a public key of the lost user proxy key with the newly received public key.

Additionally, or alternatively, if the privacy service 805 has become unavailable or compromised, the wallet application 120 may cause the proxy contract copy 800A to process a transaction that transfers all digital assets from the proxy contract copy 800A to the main contract copy 810A. For instance, the wallet application 120 may include, in the proxy recovery transaction, a public key corresponding to a replacement user proxy key and a public key corresponding to a replacement privacy service key. These public keys may be forwarded by the main contract copy 810A to the proxy contract copy 800A. If the salt value is correct, the proxy contract copy 800A may replace, respectively, public keys of the existing user proxy key and the existing privacy service key with the newly received public keys. Then, the wallet application 120 may use the replacement user proxy key and the replacement privacy service key to sign a transaction that, when processed by the proxy contract copy 800A, causes the proxy contract copy 800A to transfer some or all digital assets to the main contract copy 810A.

In this manner, the wallet application 120 may regain control of the proxy contract even if the privacy service 805 becomes unavailable or compromised, or if the wallet application 120 loses the user proxy key. However, because the layer 1 address of the main contract is submitted to the proxy contract via the reveal transaction, the link between the main contract and the proxy contract may be revealed. As a result, privacy may no longer be maintained.

Accordingly, in some embodiments, the wallet application 120 may set up another proxy contract, and may cause the existing proxy contract and/or the main contract to transfer one or more digital assets to the new proxy contract. This may be done in any suitable manner, for example, via a mixing service for digital assets, so that the new proxy contract may not be linked to the existing proxy contact or the main contract.

Again, it should be appreciated that aspects of the present disclosure are not limited to having a proxy contract or a main contract that is deployed on the distributed ledger 100. In some embodiments, a proxy contract and/or a main contract may be member contract(s) of the illustrative layer 2 service 200 in the example of FIG. 3, and may be deployed only as needed, as described in connection the example of FIG. 8A.

In such an example, if the privacy service 805 becomes unavailable or compromised, or if the wallet application 120 loses the user proxy key, the wallet application 120 may regain control by first deploying the proxy contract and/or the main contract (e.g., as described in connection the example of FIG. 6). The wallet application 120 may send to the deployed main contract a transaction to replace an existing initiation key and/or an existing approval key of the main contract. This transaction may be signed using a recovery key of the main contract. The wallet application 120 may then send to the main contract a proxy recovery transaction as described above (e.g., including the salt value used to set up the proxy contract). The proxy recovery transaction may be signed using the replacement initiation key and/or the replacement approval key. When processed by the main contract, the proxy recovery transaction may cause the main contract to send a reveal transaction to the proxy contract as described above.

Illustrative configurations of various aspects of the present disclosure are provided below.

(1) A computer-implemented method for validating distributed ledger transactions, the method comprising acts of: receiving a request to validate a proposed transaction for layer 2 processing for a distributed ledger; identifying a cryptographic configuration involved in the proposed transaction, checking the proposed transaction against one or more transaction rules of the cryptographic configuration, and in response to successfully checking the proposed transaction against the one or more transaction rules of the cryptographic configuration, participating in jointly signing the proposed transaction with a validation key associated with the cryptographic configuration.

(2) The method of configuration (1), wherein the cryptographic configuration comprises information relating to a smart contract, and the smart contract is not deployed on the distributed ledger.

(3) The method of configuration (2), wherein the proposed transaction indicates a layer 1 address of the smart contract, and the act of identifying the cryptographic configuration comprises using the layer 1 address to identify the information relating to the smart contract.

(4) The method of configuration (3), wherein the layer 1 address of the smart contract is determined based on a creator address, creation code, and/or a configuration of the smart contract.

(5) The method of configuration (1), wherein: the act of checking the proposed transaction against one or more transaction rules of the cryptographic configuration is not performed on the distributed ledger.

(6) The method of configuration (5), wherein the one or more transaction rules comprises at least one rule selected from a group consisting of: an N-out-of-M multi-signature rule, a transaction initiation rule, a transaction approval rule, a transaction amount rule, an aggregate amount rule, a blacklist rule, and a whitelist rule.

(7) The method of configuration (1), wherein the method is performed by a transaction validation service, and the act of signing the proposed transaction comprises generating, jointly with a wallet application, a joint signature over the proposed transaction, wherein the transaction validation service signs with the validation key associated with the cryptographic configuration, and the wallet application signs with a user key associated with the cryptographic configuration.

(8) A computer-implemented method for virtually updating a smart contract, the method comprising acts of receiving a proposed configuration transaction for a smart contract that is not deployed on a distributed ledger, identifying the smart contract to be updated, checking the proposed configuration transaction against one or more configuration rules of the smart contract, and in response to successfully checking the proposed configuration transaction against the one or more configuration rules of the smart contract, updating a state of the smart contract, wherein the state of the smart contract is not maintained on the distributed ledger.

(9) The method of configuration (8), wherein the one or more configuration rules comprises a key recovery rule.

(10) A computer-implemented method for deploying a smart contract, the method comprising acts of initiating a deployment transaction to deploy a smart contract on a distributed ledger, the deployment transaction being previously saved, and initiating a configuration transaction for the smart contract, the configuration transaction being saved before the smart contract is deployed.

(11) The method of configuration (10), further comprising acts of prior to initiating the deployment transaction to deploy the smart contract on the distributed ledger: sending a request to validate a proposed transaction for layer 2 processing, wherein the proposed transaction involves the smart contract, and participating in jointly signing the proposed transaction with a user key associated with the smart contract, thereby obtaining a joint signature over the proposed transaction.

(12) The method of configuration (11), further comprising an act of prior to initiating the deployment transaction to deploy the smart contract on the distributed ledger: sending the proposed transaction, along with the joint signature, to a layer 2 service for processing.

(13) The method of configuration (11), wherein the method is performed by a wallet application, the request to validate the proposed transaction is sent to a transaction validation service, and the joint signature is generated jointly with the transaction validation service, wherein: the transaction validation service signs with a validation key associated with the smart contract, and the wallet application signs with the user key associated with the smart contract.

(14) The method of configuration (10), wherein the act of initiating a deployment transaction comprises sending the deployment transaction to a factory contract configured to process the deployment transaction, and the act of initiating a configuration transaction comprises, after the smart contract has been deployed on the distributed ledger, sending the configuration transaction to the smart contract to be processed.

(15) The method of configuration (10), further comprising an act of after the smart contract has been deployed on the distributed ledger, initiating a withdrawal transaction to transfer one or more digital assets from a layer 2 service to the smart contract.

(16) A computer-implemented method for validating distributed ledger transactions, the method comprising acts of receiving a request to validate a proposed transaction for a proxy contract, wherein the proxy contract is not deployed on a distributed ledger, identifying a main contract associated with the proxy contract, checking the proposed transaction against one or more transaction rules of the main contract, and in response to successfully checking the proposed transaction against the one or more transaction rules of the main contract, signing the proposed transaction with a transaction approval key associated with the proxy contract.

(17) The method of configuration (16), wherein the proposed transaction is checked against the one or more transaction rules based on program logic and/or a state of the main contract.

(18) The method of configuration (17), wherein the main contract is deployed on the distributed ledger, and the method further comprises an act of accessing the state of the main contract from the distributed ledger.

(19) The method of configuration (17), wherein the main contract is not deployed on the distributed ledger; and the method further comprises an act of maintaining the state of the main contract.

(20) The method of configuration (17), wherein the main contract is not deployed on the distributed ledger, and the method further comprises an act of accessing, from a layer 2 service, transaction history associated with the main contract, and using the transaction history to derive the state of the main contract.

(21) The method of configuration (16), wherein the request to validate the proposed transaction is received from a wallet application, and the wallet application is configured to sign the proposed transaction with a transaction initiation key associated with the proxy contract.

(22) The method of configuration (21), wherein the act of signing the proposed transaction comprises generating, by a privacy service and the wallet application, a joint signature over the proposed transaction, the privacy service uses the transaction approval key associated with the proxy contract to generate the joint signature, and the wallet application uses the transaction initiation key associated with the proxy contract to generate the joint signature.

(23) The method of configuration (16), further comprising an act of sending the proposed transaction, with a signature generated using the transaction approval key associated with the proxy contract, to a layer 2 service for processing.

(24) A computer-implemented method for recovering a proxy contract, the method comprising acts of initiating a first deployment transaction to deploy a proxy contract on a distributed ledger, the first deployment transaction being previously saved, initiating a second deployment transaction to deploy a main contract on the distributed ledger, the second deployment transaction being previously saved, sending a first transaction to the main contract, wherein the first transaction is configured to cause the main contract to replace a public key corresponding to at least one existing transaction key for the main contract, and sending a second transaction to the main contract, wherein the second transaction is configured to cause the main contract to send a reveal transaction to the proxy contract.

(25) The method of configuration (24), wherein the public key corresponding to the at least one existing transaction key for the main contract comprises a first public key, the first transaction is configured to cause the main contract to replace the first public key with a second public key, the second public key corresponding to at least one replacement transaction key for the main contract, and the method further comprises an act of signing the second transaction using the at least one replacement transaction key for the main contract.

(26) The method of configuration (24), wherein the second transaction comprises a salt value to be used by the main contract to prepare the reveal transaction for the proxy contract.

(27) The method of configuration (25), wherein the proxy contract includes a third public key, the third public key corresponding to at least one existing transaction key for the proxy contract, the second transaction sent to the main contract comprises a fourth public key, the fourth public key corresponding to at least one replacement transaction key for the proxy contract, and the reveal transaction is configured to, when processed by the proxy contract, cause the proxy contract to replace the third public key with the fourth public key.

(28) The method of configuration (25), wherein the proxy contract comprises a first proxy contract, the method further comprises an act of sending a third transaction to the first proxy contract, the third transaction is configured to, when processed by the first proxy contract, cause the first proxy contract to transfer one or more digital assets to the main contract and/or a second proxy contract, and the third transaction is signed using the at least one replacement transaction key for the proxy contract.

(29) The method of configuration (28), wherein the one or more digital assets are transferred to the second proxy contract via a mixing service.

(30) A system comprising at least one processor, and at least one computer-readable storage medium having stored thereon instructions which, when executed, program the at least one processor to perform the method according to any of configurations 1-29.

(31) At least one computer-readable storage medium having stored thereon instructions which, when executed, program at least one processor to perform the method according to any of configurations 1-29.

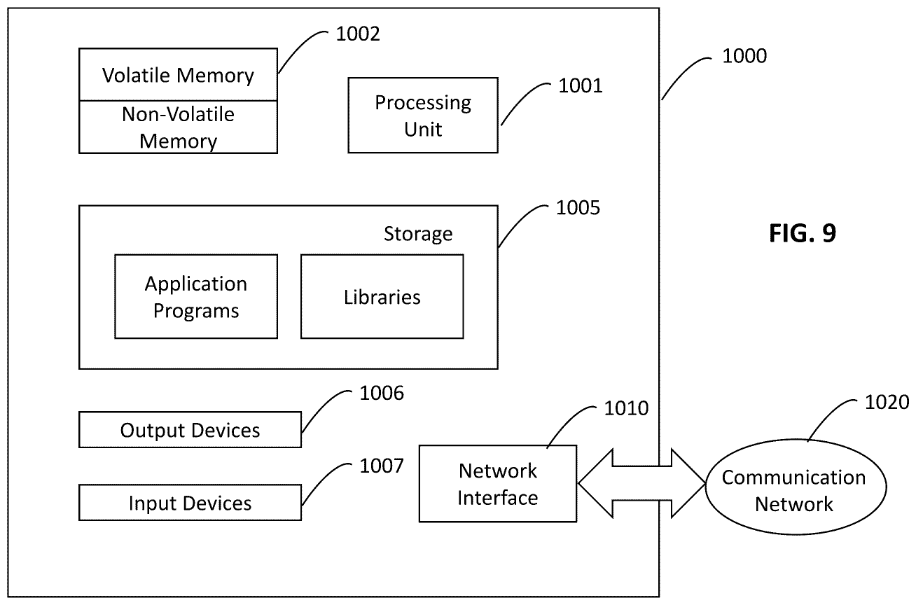

FIG. 9 shows, schematically, an illustrative computer 1000 on which any aspect of the present disclosure may be implemented.

In the example of FIG. 9, the computer 1000 includes a processing unit 1001 having one or more computer hardware processors and one or more articles of manufacture that comprise at least one non-transitory computer-readable medium (e.g., memory 1002) that may include, for example, volatile and/or non-volatile memory. The memory 1002 may store one or more instructions to program the processing unit 1001 to perform any of the functions described herein. The computer 1000 may also include other types of non-transitory computer-readable media, such as storage 1005 (e.g., one or more disk drives) in addition to the memory 1002. The storage 1005 may also store one or more application programs and/or resources used by application programs (e.g., software libraries), which may be loaded into the memory 1002. To perform any of the illustrative functionalities described herein, processing unit 1001 may execute one or more processor-executable instructions stored in the one or more non-transitory computer-readable media (e.g., the memory 1002, the storage 1005, etc.), which may serve as non-transitory computer-readable media storing processor-executable instructions for execution by the processing unit 1001.

The computer 1000 may have one or more input devices and/or output devices, such as devices 1006 and 1007 illustrated in FIG. 9. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text.

In the example of FIG. 9, the computer 1000 also includes one or more network interfaces (e.g., the network interface 1010) to enable communication via various networks (e.g., the network 1020). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more processors, perform methods that implement the various embodiments of the present disclosure discussed above. The computer-readable medium or media may be portable, such that the program or programs stored thereon may be loaded onto one or more different computers or other processors to implement various aspects of the present disclosure as discussed above.

The terms “program” or “software” are used herein to refer to any type of computer code or set of computer-executable instructions that may be employed to program one or more processors to implement various aspects of the present disclosure as discussed above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that establish how the data elements are related.

Various features and aspects of the present disclosure may be used alone, in any combination of two or more, or in a variety of arrangements not specifically discussed in the embodiments described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

1. A computer-implemented method for validating distributed ledger transactions, the method comprising acts of:
receiving a request to validate a proposed transaction for layer 2 processing for a distributed ledger;
identifying a cryptographic configuration involved in the proposed transaction;
checking the proposed transaction against one or more transaction rules of the cryptographic configuration; and
in response to successfully checking the proposed transaction against the one or more transaction rules of the cryptographic configuration, participating in jointly signing the proposed transaction with a validation key associated with the cryptographic configuration.

2. The method of claim 1, wherein:
the cryptographic configuration comprises information relating to a smart contract; and
the smart contract is not deployed on the distributed ledger.

3. The method of claim 2, wherein:
the proposed transaction indicates a layer 1 address of the smart contract; and
the act of identifying the cryptographic configuration comprises using the layer 1 address to identify the information relating to the smart contract.

4. The method of claim 3, wherein:
the layer 1 address of the smart contract is determined based on a creator address, creation code, and/or a configuration of the smart contract.

5. The method of claim 1, wherein:
the act of checking the proposed transaction against one or more transaction rules of the cryptographic configuration is not performed on the distributed ledger.

6. The method of claim 5, wherein:
the one or more transaction rules comprises at least one rule selected from a group consisting of: an N-out-of-M multi-signature rule, a transaction initiation rule, a transaction approval rule, a transaction amount rule, an aggregate amount rule, a blacklist rule, and a whitelist rule.

7. The method of claim 1, wherein:
the method is performed by a transaction validation service; and
the act of signing the proposed transaction comprises generating, jointly with a wallet application, a joint signature over the proposed transaction, wherein:
the transaction validation service signs with the validation key associated with the cryptographic configuration; and
the wallet application signs with a user key associated with the cryptographic configuration.

8. The method of claim 2, further comprising acts of:
receiving a proposed configuration transaction for the smart contract;
identifying the smart contract to be updated;
checking the proposed configuration transaction against one or more configuration rules of the smart contract; and
in response to successfully checking the proposed configuration transaction against the one or more configuration rules of the smart contract, updating a state of the smart contract, wherein the state of the smart contract is not maintained on the distributed ledger.

9. The method of claim 8, wherein:
the one or more configuration rules comprises a key recovery rule.

10. The method of claim 2, further comprising acts of:
initiating a deployment transaction to deploy the smart contract on a distributed ledger, the deployment transaction being previously saved; and
initiating a configuration transaction for the smart contract, the configuration transaction being saved before the smart contract is deployed.

11. The method of claim 10, further comprising acts of:
prior to initiating the deployment transaction to deploy the smart contract on the distributed ledger:
sending the request to validate the proposed transaction for layer 2 processing, wherein the proposed transaction involves the smart contract; and
participating in jointly signing the proposed transaction with a user key associated with the smart contract, thereby obtaining a joint signature over the proposed transaction.

12. The method of claim 11, further comprising an act of:
prior to initiating the deployment transaction to deploy the smart contract on the distributed ledger:
sending the proposed transaction, along with the joint signature, to a layer 2 service for processing.

13. The method of claim 11, wherein:
the method is performed by a wallet application;
the request to validate the proposed transaction is sent to a transaction validation service; and
the joint signature is generated jointly with the transaction validation service, wherein:
the transaction validation service signs with a validation key associated with the smart contract; and
the wallet application signs with the user key associated with the smart contract.

14. The method of claim 10, wherein:
the act of initiating a deployment transaction comprises sending the deployment transaction to a factory contract configured to process the deployment transaction; and
the act of initiating a configuration transaction comprises, after the smart contract has been deployed on the distributed ledger, sending the configuration transaction to the smart contract to be processed.

15. The method of claim 10, further comprising an act of:
after the smart contract has been deployed on the distributed ledger, initiating a withdrawal transaction to transfer one or more digital assets from a layer 2 service to the smart contract.

16. A system comprising:
at least one processor; and
at least one computer-readable storage medium having stored thereon instructions which, when executed, program the at least one processor to perform a method, the method comprising:
receiving a request to validate a proposed transaction for layer 2 processing for a distributed ledger;
identifying a cryptographic configuration involved in the proposed transaction;
checking the proposed transaction against one or more transaction rules of the cryptographic configuration; and
in response to successfully checking the proposed transaction against the one or more transaction rules of the cryptographic configuration, participating in jointly signing the proposed transaction with a validation key associated with the cryptographic configuration.

17. At least one computer-readable storage medium having stored thereon instructions which, when executed, program at least one processor to perform a method, the method comprising:
receiving a request to validate a proposed transaction for layer 2 processing for a distributed ledger;
identifying a cryptographic configuration involved in the proposed transaction;
checking the proposed transaction against one or more transaction rules of the cryptographic configuration; and
in response to successfully checking the proposed transaction against the one or more transaction rules of the cryptographic configuration, participating in jointly signing the proposed transaction with a validation key associated with the cryptographic configuration.
